(19) United States
(12) Patent Application Publication
(10) Pub. No.: US 2025/0314856 A1
(43) Pub. Date: Oct. 9, 2025

(54) VISUAL OPTICAL SYSTEM

(71) Applicant: Zhejiang Sunny Optics Co., Ltd., Yuyao City (CN)

(72) Inventors: Xiaobin ZHANG, Yuyao City (CN); Yinfang JIN, Yuyao City (CN); Liefeng ZHAO, Yuyao City (CN)

(21) Appl. No.: 19/004,328

(22) Filed: Dec. 29, 2024

(30) Foreign Application Priority Data
Apr. 9, 2024 (CN) 202410418720.3

(51) Int. Cl. G02B 9/64; G02B 5/00

(52) U.S. Cl. CPC G02B 9/64; G02B 5/005

(57) ABSTRACT

A visual optical system is provided, including a first optical system and a second optical system, the first optical system sequentially includes: a first element group, a second element group and a third element group, the first element group including a first lens element, a reflective polarizing element and a quarter wave plate; and the second optical system sequentially includes: a first lens, a second lens er, a third lens and a fourth; where, a distance TDm from a first side surface of the first element group to a second side surface of the third element group on the first optical axis and a distance TDe from a first surface of the first lens to a second surface of the fourth lens on the second optical axis satisfy: 5.0<TDm/TDe<15.0.

### CROSS-REFERENCE TO RELATED APPLICATIONS

This application claims the benefit from Chinese Patent Application No. 202410418720.3, filed on Apr. 9, 2024 before the China National Intellectual Property Administration, the entire disclosure of which is incorporated herein by reference in its entity.

### TECHNICAL FIELD

The present disclosure relates to the field of optical elements, in particular to a visual optical system.

### BACKGROUND

VR (Virtual Reality) technology creates lifelike simulated environments, immersing users in various environments and bringing significant changes to fields such as social interaction, entertainment, healthcare, and education.

As VR technology continues to evolve, consumers' demands for interactive VR experiences are increasing. However, consumers' demands are difficult to fulfill due to the limited storage space and computing capabilities of VR hardware. In order to address the screen-door effect caused by insufficient resolution in LCD (Liquid Crystal Display) screens, higher-resolution LCD screens or Micro-OLED (Micro Organic Light Emitting Display) screens are required. However, increasing the resolution also entails the need for more storage space and computing power. To address the issue of insufficient computing power, local rendering of display images can be implemented, with the prerequisite of Eye Tracking functionality. Currently, Eye Tracking Cameras (eye tracking systems) are typically placed on the bracket near the eye-end of VR devices, making them visible to the user and thus affecting the aesthetic appeal of VR device products.

### SUMMARY

According to an embodiment of the present disclosure, a visual optical system is provided, including a first optical system and a second optical system, the first optical system sequentially includes: a first element group, a second element group and a third element group along a first optical axis from a near-eye side to a display side, the first element group including a first lens element, a reflective polarizing element and a quarter wave plate; the second element group including a second lens element; and the third element group including a third lens element; the second optical system sequentially includes: a first lens having a refractive power, a second lens having a positive refractive power, a third lens having a positive refractive power and a fourth lens having a refractive power along a second optical axis from a first side to a second side; where, a distance TDm from a first side surface of the first element group to a second side surface of the third element group on the first optical axis and a distance TDe from a first surface of the first lens to a second surface of the fourth lens on the second optical axis satisfy: 5.0<TDm/TDe<15.0.

In one or more embodiments, a focal length f1m of the first element group and a focal length f3m of the third element group satisfy: 0.3<f1m/f3m<2.5.

In one or more embodiments, the distance TDm from the first side surface of the first element group to the second side surface of the third element group on the first optical axis and a focal length f3m of the third element group satisfy: −0.01<TDm/f3m<0.50.

In one or more embodiments, the distance TDm from the first side surface of the first element group to the second side surface of the third element group on the first optical axis and a center thickness CT3m of the third lens element on the first optical axis satisfy: 0.1<CT3m/TDm<0.9.

In one or more embodiments, a refractive index N1m of the first lens element, a refractive index N2m of the second lens element, an air spacing T12m between the first element group and the second element group on the first optical axis, a focal length f1m of the first element group, and a focal length f2m of the second element group satisfy: −3.5<(N1m+N2m)*T12m/(f2m/f1m)<2.0.

In one or more embodiments, a refractive index N3m of the third lens element and a refractive index N1e of the first lens satisfy: 0.8<N3m/N1e<1.20; and an abbe number V3m of the third lens element and an abbe number V1e of the first lens satisfy: 0<|V3m−V1e|<40.0.

In one or more embodiments, a distance TTLe from the first surface of the first lens to an image plane on the second optical axis and the distance TDe from the first surface of the first lens to the second surface of the fourth lens on the second optical axis satisfy: 1.30<TTLe/TDe<1.80.

In one or more embodiments, a refractive index N2e of the second lens, a refractive index N3e of the third lens, a center thickness CT2e of the second lens on the second optical axis and a center thickness CT3e of the third lens on the second optical axis satisfy: 0.2<(N2e*CT2e)/(N3e*CT3e)<1.8.

In one or more embodiments, a focal length f1e of the first lens and a focal length f2e of the second lens satisfy: −1.50<f1e/f2e<0.09.

In one or more embodiments, a focal length f3e of the third lens and a focal length f4e of the fourth lens satisfy: 0.01<|f3e/f4e|<1.20.

In one or more embodiments, a radius of curvature Rim of a first side surface of the first lens element and a radius of curvature R3m of a first side surface of the second lens element satisfy: 0<R1m/R3m<1.0.

In one or more embodiments, a radius of curvature R5m of a first side surface of the third lens element and a radius of curvature Rom of a second side surface of the third lens element satisfy: −2.0<R6m/R5m<2.0.

In one or more embodiments, a radius of curvature R1e of the first surface of the first lens and a radius of curvature R8e of the second surface of the fourth lens satisfy: −5.0<|R8e|/R1e<0.

In one or more embodiments, a focal length f3e of the third lens, a radius of curvature R5e of a first surface of the third lens, and a radius of curvature Roe of a second surface of the third lens satisfy: −2.0<f3e/(R5e+R6e)<0.

In one or more embodiments, a total focal length f of the visual optical system satisfies: 0.8<f<1.5.

In one or more embodiments, the second optical system is disposed between the first optical system and the display side, the first side of the second optical system is relatively closer to the near-eye side, and the second side of the second optical system is relatively closer to the display side.

In one or more embodiments, an included angle θ between the second optical axis and the first optical axis satisfies: 0°<θ<90°.

In one or more embodiments, the second optical system further includes a diaphragm, and the diaphragm is disposed on a side closer to the first surface of the first lens; and a spacing distance Tz along the first optical axis from an intersection point of the second side surface of the element group closest to the display side in the first optical system and the first optical axis, to an intersection point of a center of the diaphragm in the second optical system and the second optical axis satisfy: 0 mm<Tz<15.0 mm.

In one or more embodiments, the second optical system further includes a diaphragm, and the diaphragm is disposed on a side closer to the first surface of the first lens; and a spacing distance Ty along a direction perpendicular to the first optical axis from an intersection point of the second side surface of the element group closest to the display side in the first optical system and the first optical axis, to an intersection point of a center of the diaphragm in the second optical system and the second optical axis satisfy: 5 mm<Ty<25.0 mm.

In one or more embodiments, a second side surface of the first lens element is at least partially attached to the reflective polarizing element, and a second side surface of the reflective polarizing element is at least partially attached to the quarter wave plate; and the second side surface of the first lens element is a planar surface.

The visual optical system provided according to embodiments of the present disclosure may include the first optical system and the second optical system, the first optical system uses the reflective polarizing element and the quarter wave plate to achieve optical path redirection, where the quarter wave plate may change a polarization state of polarized light, so that circularly-polarized light changes to s-polarized light or p-polarized light, and the reflective polarizing element may transmit or reflect the s-polarized light or p-polarized light, so as to redirect the optical path, and reduce a total length of a near-eye display system. The second optical system may form an eye tracking system with the first optical system, and by controlling a ratio of an axial length of the first optical system to an axial length of the second optical system, miniaturization of the second optical system can be well controlled, which is conducive to ensuring an eye tracking function while keeping the second optical system invisible, thereby improving the practicality and aesthetics of VR devices.

### BRIEF DESCRIPTION OF THE DRAWINGS

By reading detailed description of non-limiting embodiments with reference to the following accompanying drawings, other features, objectives and advantages of the present disclosure will be more apparent:

FIG. 1 is a schematic structural diagram of a visual optical system according to an exemplary embodiment of the present disclosure;

FIG. 2 is an enlarged schematic diagram of a second optical system in the visual optical system in FIG. 1;

FIG. 3 is a schematic structural diagram of a visual optical system according to Embodiment 1 of the present disclosure;

FIG. 4 is a schematic diagram of a second optical system of the visual optical system according to Embodiment 1 of the present disclosure;

FIG. 5 is a schematic diagram of an MTF curve of the visual optical system according to Embodiment 1 of the present disclosure;

FIG. 6 is a schematic structural diagram of a visual optical system according to Embodiment 2 of the present disclosure;

FIG. 7 is a schematic diagram of a second optical system of the visual optical system according to Embodiment 2 of the present disclosure;

FIG. 8 is a schematic diagram of an MTF curve of the visual optical system according to Embodiment 2 of the present disclosure;

FIG. 9 is a schematic structural diagram of a visual optical system according to Embodiment 3 of the present disclosure;

FIG. 10 is a schematic diagram of a second optical system of the visual optical system according to Embodiment 3 of the present disclosure;

FIG. 11 is a schematic diagram of an MTF curve of the visual optical system according to Embodiment 3 of the present disclosure;

FIG. 12 is a schematic structural diagram of a visual optical system according to Embodiment 4 of the present disclosure;

FIG. 13 is a schematic diagram of a second optical system of the visual optical system according to Embodiment 4 of the present disclosure; and

FIG. 14 is a schematic diagram of an MTF curve of the visual optical system according to Embodiment 4 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. Furthermore, when an expression such as “at least one of . . . ” appears before a list of features, it modifies the entire list of features, rather than individual elements within the list. In addition, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The following embodiments illustrate only several implementations of the present disclosure, and their descriptions are more specific and detailed, but they are not to be construed as a limitation to the scope of patent of the present disclosure. It should be noted that, for those of ordinary skill in the art, without departing from the concept of the present disclosure, a number of modifications and improvements can be made, which all fall within the scope of protection of the present disclosure.

Detailed descriptions of the features, principles, and other aspects of the present disclosure are provided below.

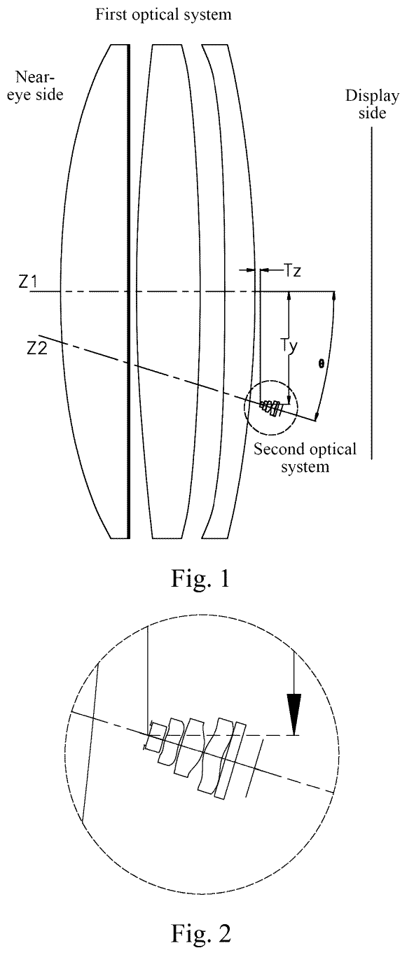

Referring to FIG. 1, a visual optical system according to exemplary embodiments of the present disclosure may include a first optical system and a second optical system.

In the exemplary embodiments, the first optical system may include a first element group, a second element group, and a third element group sequentially disposed along a first optical axis Z1 from a first side to a second side, where the first element group may include a first lens element, a reflective polarizing element and a quarter wave plate, the second element group may include a second lens element, and the third element group may include a third lens element. There may be an air spacing between the first element group and the second element group, and between the second element group and the third element group.

In the exemplary embodiments, the first side may be a near-eye side, and the second side may be a display side. Accordingly, each element group (the first element group, the second element group, and the third element group) and each optical element (the first lens element, the reflective polarizing element, the quarter wave plate, the second lens element, the third lens element, or the like) in the first optical system may have a first side surface relatively closer to the near-eye side and a second side surface relatively closer to the display side.

Referring to FIG. 2, in the exemplary embodiments, the second optical system may include a first lens, a second lens, a third lens, and a fourth lens sequentially disposed along a second optical axis Z2 from a first side to a second side. There may be an air spacing between two adjacent lenses in the first lens to the fourth lens.

In the exemplary embodiments, the first lens may have a positive refractive power or a negative refractive power; the second lens may have a positive refractive power; the third lens may have a positive refractive power; and the fourth lens may have a positive refractive power or a negative refractive power.

In the exemplary embodiments, the first optical system may, for example, be configured as a catadioptric near-eye display system, the second optical system may, for example, be configured as an infrared band imaging system, and the second optical system may form an eye tracking system with the first optical system.

Exemplarily, the second optical system may be utilized to form an image of a real-world scene, and this real image is then transmitted to a display screen in the form of electrical signals. The first optical system is used for projecting the virtual image on the display screen and the real image transmitted onto the screen, such as projecting them into the user's eyes. This enables the user to perceive a combined view of both virtual and real images, enhancing the user's sense of immersion.

Exemplarily, the visual optical system according to exemplary embodiments of the present disclosure may be used in a variety of virtual reality display devices, such as VR headsets, or AR (Augmented Reality) electronic devices.

In the exemplary embodiments, the reflective polarizing element may be disposed on the second side surface of the first lens element and at least partially attached to the second side surface of the first lens element; and the quarter wave plate may be disposed on the second side surface of the reflective polarizing element and at least partially attached to the second side surface of the reflective polarizing element. The quarter wave plate may change a polarization state of polarized light, so that circularly-polarized light changes to s-polarized light or p-polarized light, as light passes through the reflective polarizing element, the reflective polarizing element may transmit or reflect the s-polarized light or p-polarized light, so as to redirect an optical path, and reduce a total length of the near-eye display system.

In the exemplary embodiments, the first optical system may further include a partially reflective layer, which may be affixed to the first side surface or the second side surface of the second lens element, or, the partially reflective layer may be affixed to the first side surface or the second side surface of the third lens element. The partially reflective layer has a semi-transmissive and semi-reflective effect on the light. By providing the partially reflective layer and combining with the reflective polarizing element and the quarter wave plate, the light can be refracted and reflected a number of times, thereby effectively reducing a body length of the first optical system.

In conjunction with FIG. 1, in the exemplary embodiments, the second optical system may be disposed between the first optical system and the display side (display screen), with the first side of the second optical system being relatively closer to the near-eye side and the second side of the second optical system being relatively closer to the display side. Thus, first surfaces of the first lens, the second lens, the third lens, and the fourth lens in the second optical system are relatively closer to the near-eye side, and second surfaces of the first lens, the second lens, the third lens, and the fourth lens are relatively closer to the display side. By disposing the second optical system between the first optical system and the display (display screen), the eye tracking function of the second optical system is ensured without compromising performance of the first optical system, and the appearance of head-mounted virtual reality devices is improved, so that the second optical system is invisible to the eye, thereby improving the aesthetics of the product.

The visual optical system according to the exemplary embodiments of the present disclosure may satisfy: 5.0<TDm/TDe<15.0, where TDm is a distance from the first side surface of the first element group to the second side surface of the third element group on the first optical axis, and TDe is a distance from the first surface of the first lens to the second surface of the fourth lens on the second optical axis. Satisfying 5.0<TDm/TDe<15.0, and reasonably controlling the ratio of the axial length of the first optical system to the axial length of the second optical system, miniaturization of the second optical system can be well controlled, which is conducive to disposing the second optical system between the first optical system and the screen, so as to make the second optical system invisible to the eye, and improve the aesthetics of the product. In addition, miniaturization can be achieved while ensuring the eye tracking function.

In the exemplary embodiments, the visual optical system may satisfy: 0.3<f1m/f3m<2.5, where f1m is a focal length of the first element group, and f3m is a focal length of the third element group. Satisfying 0.3<f1m/f3m<2.5, on the one hand, keeps a difference between the focal lengths of the two element groups to be small, and indirectly controls sagittal heights of the two element groups in large-diameter optical systems, which is conducive to molding of the two element groups; and on the other hand, reduces the influence of aberrations introduced by the two element groups on the second optical system, when the focal lengths of the two element groups are both large.

In the exemplary embodiments, the visual optical system may satisfy: −0.01<TDm/f3m<0.50, where TDm is the distance from the first side surface of the first element group to the second side surface of the third element group on the first optical axis, and f3m is the focal length of the third element group. Satisfying −0.01<TDm/f3m<0.50, by controlling the ratio of the distance from the first side surface of the first element group to the second side surface of the third element group on the first optical axis to the focal length of the third element group, TDm can be small, which is conducive to controlling a mechanical length of the first optical system.

In the exemplary embodiments, the visual optical system may satisfy: 0.1<CT3m/TDm<0.9, where TDm is the distance from the first side surface of the first element group to the second side surface of the third element group on the first optical axis, and CT3m is a center thickness of the third lens element on the first optical axis. Satisfying 0.1<CT3m/TDm<0.9, controlling the ratio of the axial distance from the first side surface of the first element group to the second side surface of the third element group to the center thickness of the third lens element, is conducive to controlling the thickness of the third lens element, thereby improving assembly stability.

In the exemplary embodiments, the visual optical system may satisfy: −3.5<(N1m+N2m)*T12m/(f2m/f1m)<2.0, where N1m is a refractive index of the first lens element, N2m is a refractive index of the second lens element, T12m is an air spacing between the first element group and the second element group on the first optical axis, f1m is the focal length of the first element group, and f2m is a focal length of the second element group. Satisfying −3.5<(N1m+N2m)*T12m/(f2m/f1m)<2.0, controlling the correlational relationship among the refractive indices, focal lengths and air spacing of the first lens element in the first element group and the second lens element in the second element group, is conducive to controlling an angle of incidence of reflected light on the second side surface of the first element group, thereby controlling an angle of incidence of the light on the reflective polarizing element, which is conducive to improving a reflection efficiency of the reflected light and reducing light leakage.

In the exemplary embodiments, the visual optical system may satisfy: 0.8<N3m/N1e<1.20 and 0<|V3m−V1e|<40.0, where N3m is a refractive index of the third lens element, N1e is a refractive index of the first lens, V3m is an abbe number of the third lens element, and V1e is an abbe number of the first lens. Satisfying 0.8<N3m/N1e<1.20 and 0<|V3m−V1e|<40.0, by controlling the relative relationship between the refractive indices of the third lens element and the first lens and the relative relationship between the abb numbers of the third lens element and the first lens, material selection of the third lens element and the first lens is controlled. The material selection of the third lens element requires low stress, generally low refractive index and high abbe number, and the first lens, as a first lens element in the infrared band imaging system, the material selection generally requires low refractive index and high abbe number or medium refractive index and medium abbe number.

In the exemplary embodiments, the visual optical system may satisfy: 1.30<TTLe/TDe<1.80, where TTLe is a distance from the first surface of the first lens to an image plane on the second optical axis, and TDe is the distance from the first surface of the first lens to the second surface of the fourth lens on the second optical axis. Satisfying 1.30<TTLe/TDe<1.80, by controlling the ratio of the distance from the first surface of the first lens to the image plane to the distance from the first surface of the first lens to the second surface of the fourth lens, the size of a back-focus of the second optical system can be effectively controlled, which is conducive to thickness selection of an IR (infrared sensor) chip.

In the exemplary embodiments, the visual optical system may satisfy: 0.2<(N2e*CT2e)/(N3e*CT3e)<1.8, where N2e is a refractive index of the second lens, N3e is a refractive index of the third lens, CT2e is a center thickness of the second lens on the second optical axis, and CT3e is a center thickness of the third lens on the second optical axis. Satisfying 0.2<(N2e*CT2e)/(N3e*CT3e)<1.8, controlling the ratio of the refractive index and the thickness of the second lens to the refractive index and the thickness the third lens, is conducive to controlling the refractive powers of the second lens and the third lens, therefore, is conducive to controlling heights of the light rays passing through the second lens and the third lens, which is beneficial for matching the shape of the lens barrel.

In the exemplary embodiments, the visual optical system may satisfy: −1.50<f1e/f2e<0.09, where f1e is a focal length of the first lens, and f2e is a focal length of the second lens. Satisfying −1.50<f1e/f2e<0.09, by controlling the ratio of the focal length of the first lens to the focal length of the second lens, the opposite refractive powers of the first lens and the second lens are made opposite. This combination of positive and negative optical powers is conducive to correcting the aberrations of the system.

In the exemplary embodiments, the visual optical system may satisfy: 0.01<|f3e/f4e|<1.20, where f3e is a focal length of the third lens, and f4e is a focal length of the fourth lens. Satisfying 0.01<|f3e/f4e|<1.20, by controlling the ratio of the focal length of the third lens to the focal length of the fourth lens, the focal length of the fourth lens is greater than the focal length of the third lens, which is conducive to compression of light rays by the fourth lens, thereby reducing an angle of incidence of the light on the image plane.

In the exemplary embodiments, the visual optical system may satisfy: 0<R1m/R3m<1.0, where R1m is a radius of curvature of the first side surface of the first lens element, and R3m is a radius of curvature of the first side surface of the second lens element. Satisfying 0<R1m/R3m<1.0, by controlling the ratio of the radius of curvature of the first side surface of the first lens element to the radius of curvature of the first side surface of the second lens element, it is conducive to increasing the refractive power of the first lens element, thereby reducing the height of light on the second lens element and the third lens element.

In the exemplary embodiments, the visual optical system may satisfy: −2.0<R6m/R5m<2.0, where R5m is a radius of curvature of the first side surface of the third lens element, and Rom is a radius of curvature of the second side surface of the third lens element. Satisfying −2.0<R6m/R5m<2.0, by controlling the ratio of the radius of curvature of the first side surface of the third lens element to the radius of curvature of the second side surface of the third lens element, a shape of the third lens element, in particular, the second side surface of the third lens element, is effectively controlled, so that the radius of curvature of the second side surface of the third lens element is small, which is conducive to compression of reflected light for the first time on one hand, and is conducive to compression of transmitted light for the second time on the other hand.

In the exemplary embodiments, the visual optical system may satisfy: −5.0<|R8e|/R1e<0, where R1e is a radius of curvature of the first surface of the first lens, and R8e is a radius of curvature of the second surface of the fourth lens. Satisfying-5.0<|R8e|/R1e<0, by controlling the ratio of the radius of curvature of the first surface of the first lens to the radius of curvature of the second surface of the fourth lens, and making the radius of curvature of the first surface of the first lens negative, combined with a front-placed diaphragm, it is conducive to increasing a field-of-view of the optical system.

In the exemplary embodiments, the visual optical system may satisfy: −2.0<f3e/(R5e+R6e)<0, where f3e is the focal length of the third lens, R5e is a radius of curvature of the first surface of the third lens, and Roe is a radius of curvature of the second surface of the third lens. Satisfying −2.0<f3e/(R5e+R6e)<0, by controlling the ratio of the focal length of the third lens to the sum of the curvature radii of the surfaces of the third lens, the center thickness of the third lens can be effectively controlled, which is conducive to molding of the third lens on the one hand, and to controlling internal reflection ghost images of the third lens on the other hand.

In the exemplary embodiments, a total focal length f of the visual optical system may satisfy: 0.8<f<1.5. Satisfying 0.8<f<1.5, by controlling the total focal length of the visual optical system to be small, it is conducive to increasing the field-of-view of the visual optical system, thereby enabling the system to capture more eye movement information.

In the exemplary embodiments, the second optical axis Z2 of the second optical system has a certain included angle with the first optical axis Z1 of the first optical system, and the included angle θ satisfies: 0°<θ<90°. By controlling the included angle between the second optical axis of the second optical system and the first optical axis of the first optical system, on the one hand, the second optical system can be disposed outside the first optical system, thereby ensuring functions of the first optical system, on the other hand, the second optical system can photograph images of the eyeball, thereby accomplishing eye tracking.

In the exemplary embodiments, the second optical system of the visual optical system further includes a diaphragm, the diaphragm may be disposed on a side closer to the first surface of the first lens, and the visual optical system may satisfy: 0 mm<Tz<15.0 mm, where Tz is a spacing distance along the first optical axis from an intersection point of the second side surface of the element group closest to the display side in the first optical system and the first optical axis, to an intersection point of a center of the diaphragm in the second optical system and the second optical axis. The visual optical system may further satisfy: 0 mm<Tz<10.0 mm, by controlling the above spacing distance, z-direction heights of the second optical system and the first optical system can be controlled, thereby effectively controlling the second optical system to be located between the first optical system and the screen, and ensuring the feasibility of the eye tracking solution.

In the exemplary embodiments, the visual optical system may satisfy: 5 mm<Ty<25.0 mm, where Ty is a spacing distance along a direction perpendicular to the first optical axis, from the intersection point of the second side surface of the element group closest to the display side in the first optical system and the first optical axis, to the intersection point of the center of the diaphragm in the second optical system and the second optical axis. The visual optical system may further satisfy: 11.41 mm≤Ty≤18.39 mm, by controlling the above spacing distance, a diameter of a bracket of the second optical system may be controlled, so that the diameter of the bracket of the second optical system is between a diameter of the first optical system and a size of the screen, which is conducive to assembly of the second optical system.

In the exemplary embodiments, in the first optical system of the visual optical system, the second side surface of the first lens element is attached to the reflective polarizing element, and the second side surface of the reflective polarizing element is attached to the quarter wave plate. The second side surface of the first lens element may be a planar surface. Exemplarily, the first lens element in the near-eye display system employs a flat film lamination method, where a composite film composed of the reflective polarizing element and the quarter wave plate is affixed to the second side surface of the first lens element, which is conducive to reducing the influence of an orange peel film on performance.

For the visual optical system according to the above embodiments of the present disclosure, by reasonably setting parameters such as the radius of curvature, the center thickness, the surface shape, the refractive index and the abbe number of each optical element group and each optical element, as well as the total effective focal length of the visual optical system, it is conducive to improving an imaging effect, and ensuring an optical performance of the system; and by reasonably setting parameters such as the position of the diaphragm, the air spacing between lenses, and the distance to the display or the image plane, it is conducive to ensuring the molding and strength of the lenses, to reducing sensitivity of the lenses; at the same time, it is conducive to restraining the total length of the optical system, and improving portability of the device; and may also enlarge the field-of-view, and improve user experience.

Specific embodiments of the visual optical system that may be applicable to the above embodiments are further described below with reference to the accompanying drawings.

### Embodiment 1

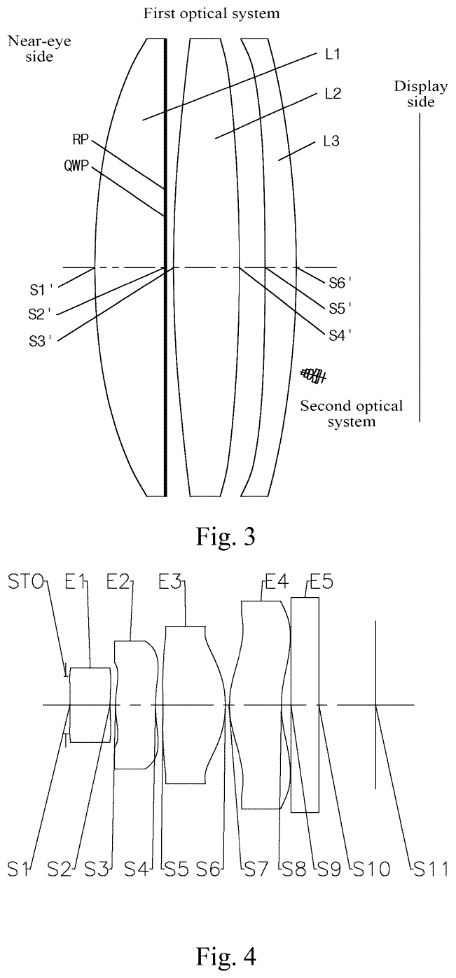

A visual optical system according to Embodiment 1 of the present disclosure is described below with reference to FIGS. 3-5.

As shown in FIG. 3, the visual optical system in this embodiment may include a first optical system and a second optical system. The first optical system includes: a first element group, a second element group, and a third element group sequentially arranged along a first optical axis from a near-eye side to a display side, where the first element group includes a first lens element L1, a reflective polarizing element RP, and a quarter wave plate QWP; the second element group includes a second lens element L2; and the third element group includes a third lens element L3. A display may be arranged on a second side of the first optical system.

In this embodiment, the first lens element L1 has a positive refractive power, a first side surface S1′ of the first lens element L1 is a convex surface, and a second side surface S2′ of the first lens element L1 is a planar surface. The reflective polarizing element RP is at least partially attached to the second side surface S2′ of the first lens element L1, and the quarter wave plate QWP is at least partially attached to a second side surface of the reflective polarizing element RP.

The second lens element L2 has a positive refractive power, a first side surface S3′ of the second lens element L2 is a convex surface, and a second side surface S4′ of the second lens element L2 is a convex surface.

The third lens element L3 has a positive refractive power, a first side surface S5′ of the third lens element L3 is a concave surface, and a second side surface S6′ of the third lens element L3 is a convex surface.

As shown in FIG. 4, the second optical system includes: a first lens E1, a second lens E2, a third lens E3, and a fourth lens E4 sequentially arranged along a second optical axis from an object side to an image side.

In this embodiment, the first lens E1 may have a negative refractive power, a first surface S1 of the first lens E1 is a concave surface, and a second surface S2 of the first lens E1 is a concave surface. The second lens E2 may have a positive refractive power, a first surface S3 of the second lens E2 is a convex surface, and a second surface S4 of the second lens E2 is a concave surface. The third lens E3 may have a positive refractive power, a first surface S5 of the third lens E3 is a concave surface, and a second surface S6 of the third lens E3 is a convex surface. The fourth lens E4 may have a positive refractive power, a first surface S7 of the fourth lens E4 is a convex surface, and a second surface S8 of the fourth lens E4 is a concave surface.

As an exemplary embodiment, the second optical system may further include a diaphragm STO, and the diaphragm may be disposed on a side closer to the first surface of the first lens E1. The second optical system may further include a protective glass or an optical filter E5 for protecting a photosensitive element disposed on an image plane S11.

Table 1 shows a table of basic parameters of the visual optical system in Embodiment 1. Here, the units of a radius of curvature and a thickness/distance are millimeters (mm).

TABLE 1

| | | | | | | conic |
|---|---|---|---|---|---|---|
| surface | surface | radius of | thick- | refractive | abbe | coef- |
| number | type | curvature | ness | index | number | ficient |
| near- | spherical | infinite | 15.0000 | | | |
| eye | | | | | | |
| side | | | | | | |
| S1′ | aspheric | 94.2231 | 7.1462 | 1.54 | 55.92 | 0.0000 |
| S2′ | spherical | infinite | 0.1000 | 1.50 | 56.00 | |
| RP | spherical | infinite | 0.1000 | 1.50 | 56.00 | |
| QWP | spherical | infinite | 0.5000 | | | |
| S3′ | aspheric | 173.6732 | 7.0000 | 1.54 | 55.92 | 0.0000 |
| S4′ | aspheric | −197.7719 | 2.5056 | | | 0.0000 |
| S5′ | aspheric | −399.9734 | 3.5000 | 1.54 | 55.92 | 0.0000 |
| S6′ | aspheric | −114.4096 | 0.0000 | | | 0.0000 |
| | | | Tz/Ty | | | |
| STO | spherical | infinite | 0.0304 | | | |
| S1 | aspheric | −11.6649 | 0.3000 | 1.57 | 29.91 | 0.0000 |
| S2 | aspheric | 1.0742 | 0.0404 | | | 0.0000 |
| S3 | aspheric | 0.5400 | 0.3000 | 1.65 | 19.24 | 0.0000 |
| S4 | aspheric | 0.9512 | 0.0561 | | | 0.0000 |
| S5 | aspheric | −2.4888 | 0.4668 | 1.54 | 56.14 | 0.0000 |
| S6 | aspheric | −0.6853 | 0.0300 | | | 0.0000 |
| S7 | aspheric | 0.6339 | 0.3925 | 1.65 | 19.24 | −1.0000 |
| S8 | aspheric | 0.8954 | 0.0713 | | | 0.0000 |
| S9 | spherical | infinite | 0.2100 | 1.52 | 64.20 | |
| S10 | spherical | infinite | 0.4300 | | | |
| S11 | spherical | infinite | −0.0050 | | | |
| display | | | | | | |
| side | | | | | | |

In this Embodiment, the first side surface S1′ of the first lens element L1, the first side surface S3′ and the second side surface S4′ of the second lens element L2, the first side surface S5′ and the second side surface S6′ of the third lens element L3, the first surface S1 and the second surface S2 of the first lens E1, the first surface S3 and the second surface S4 of the second lens E2, the first surface S5 and the second surface S6 of the third lens E3, and the first surface S7 and the second surface S8 of the fourth lens E4 are all aspheric surfaces, and the surface type x of each aspheric lens may be defined using, but not limited to, the following aspheric formula:

$$x = \frac{{ch}^{2}}{1 + \sqrt{1 - ( k + 1 ) {c}^{2} {h}^{2}}} + \sum {Aih}^{i} \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 2 shows the high-order coefficients A₄, A₆, A₈, A₁₀, A₁₂, A₁₄ and A₁₆ applicable to the aspheric surfaces in Embodiment 1.

TABLE 2

| surface | coefficient | | | | | | |
|---|---|---|---|---|---|---|---|
| number | A4 | A6 | A8 | A10 | A12 | A14 | A16 |
| S1′ | 1.7237E+00 | −1.0531E−02 | 1.8280E−02 | 1.1790E−02 | 1.9481E−03 | −2.2963E−03 | 4.9674E−04 |
| S3′ | −1.7897E−01 | −4.5955E−02 | 3.6542E−02 | −2.4898E−03 | −5.2026E−03 | 4.4163E−03 | −1.1827E−03 |
| S4′ | −2.0077E−01 | −2.0784E−01 | −3.5027E−02 | 3.7970E−03 | 1.8428E−02 | 1.3874E−02 | −7.2088E−04 |
| S5′ | −1.7781E+00 | −4.2544E−01 | −1.1943E−01 | −2.8744E−02 | 5.6071E−03 | 9.3229E−03 | 1.8844E−03 |
| S6′ | −1.0784E−01 | −6.9805E−02 | −8.2343E−03 | 0.0000E+00 | 0.0000E+00 | 0.0000E+00 | 0.0000E+00 |
| S1 | 9.7313E−03 | −2.9451E−03 | −9.1754E−04 | 1.9580E−04 | −1.7899E−04 | 4.5136E−05 | −6.1431E−05 |
| S2 | −3.2863E−02 | 3.4397E−03 | −8.8822E−04 | 1.8945E−04 | 2.4553E−05 | −3.8122E−05 | 1.0442E−05 |
| S3 | −1.0712E−01 | 3.0855E−03 | −3.0317E−03 | 5.5134E−04 | −2.6057E−05 | 7.6738E−05 | −2.2467E−05 |
| S4 | −8.9602E−02 | −2.2287E−03 | 1.3166E−04 | 1.1821E−04 | −2.3671E−04 | 5.2161E−05 | −2.7513E−06 |
| S5 | 9.8766E−02 | −2.0941E−02 | 7.2624E−03 | −3.5343E−03 | 1.6253E−03 | 4.5222E−04 | −4.9459E−04 |
| S6 | 6.8644E−02 | 1.8287E−02 | 2.7685E−03 | −7.5355E−04 | 1.7051E−04 | −6.0324E−04 | 1.8412E−04 |
| S7 | −3.0163E−01 | 1.9931E−02 | 1.8006E−03 | 1.3702E−03 | 5.3668E−04 | −9.0251E−04 | −2.4516E−04 |
| S8 | −4.5789E−01 | 9.3755E−03 | 3.5542E−03 | 1.4647E−04 | 3.7005E−03 | −1.5009E−03 | 6.8907E−04 |

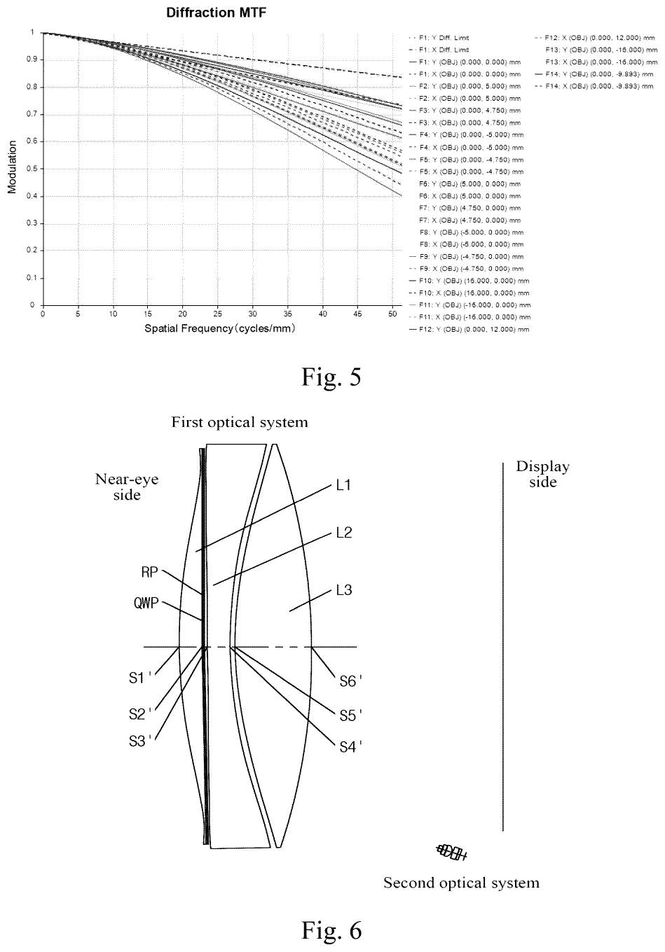

FIG. 5 illustrates a diffraction MTF (Modulation Transfer Function) curve graph of the visual optical system according to Embodiment 1 at different fields-of-view. Here, the horizontal axis, Spatial Frequency, represents the spatial frequency in line pairs per millimeter (lp/mm), and the vertical axis, Modulation, represents the Modulation Transfer Function. As can be seen from FIG. 5, the visual optical system of this embodiment exhibits good contrast within a spatial frequency of 30 lp/mm, demonstrating a high overall resolution level.

### Embodiment 2

A visual optical system according to Embodiment 2 of the present disclosure is described below with reference to FIGS. 6-8. FIG. 6 is a schematic structural diagram of the visual optical system according to Embodiment 2 of the present disclosure. In this embodiment and the following embodiments, for the sake of brevity, some descriptions similar to those in Embodiment 1 will be omitted.

As shown in FIG. 6, the visual optical system in this embodiment may include a first optical system and a second optical system. The first optical system includes: a first element group, a second element group, and a third element group sequentially arranged along a first optical axis from a near-eye side to a display side, where the first element group includes a first lens element L1, a reflective polarizing element RP, and a quarter wave plate QWP; the second element group includes a second lens element L2; and the third element group includes a third lens element L3. A display may be arranged on a second side of the first optical system.

In this embodiment, the first lens element L1 has a positive refractive power, a first side surface S1′ of the first lens element L1 is a convex surface, and a second side surface S2′ of the first lens element L1 is a planar surface. The reflective polarizing element RP is at least partially attached to the second side surface S2′ of the first lens element L1, and the quarter wave plate QWP is at least partially attached to a second side surface of the reflective polarizing element RP.

The second lens element L2 has a negative refractive power, a first side surface S3′ of the second lens element L2 is a convex surface, and a second side surface S4′ of the second lens element L2 is a concave surface.

The third lens element L3 has a positive refractive power, a first side surface S5′ of the third lens element L3 is a convex surface, and a second side surface S6′ of the third lens element L3 is a convex surface.

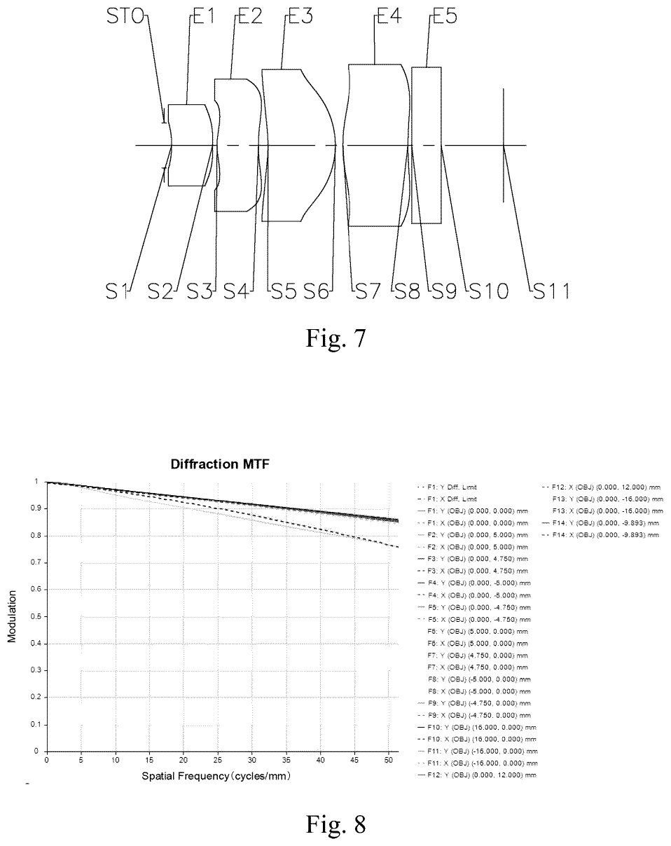

As shown in FIG. 7, the second optical system includes: a first lens E1, a second lens E2, a third lens E3, and a fourth lens E4 sequentially arranged along a second optical axis from an object side to an image side. The second optical system may further include a diaphragm STO disposed on a side closer to a first surface of the first lens E1, and a protective glass or an optical filter E5 for protecting a photosensitive element disposed on an image plane S11.

In this embodiment, the first lens E1 may have a negative refractive power, the first surface S1 of the first lens E1 is a concave surface, and a second surface S2 of the first lens E1 is a convex surface. The second lens E2 may have a positive refractive power, a first surface S3 of the second lens E2 is a convex surface, and a second surface S4 of the second lens E2 is a concave surface. The third lens E3 may have a positive refractive power, a first surface S5 of the third lens E3 is a concave surface, and a second surface S6 of the third lens E3 is a convex surface. The fourth lens E4 may have a positive refractive power, a first surface S7 of the fourth lens E4 is a convex surface, and a second surface S8 of the fourth lens E4 is a concave surface.

Table 3 shows a table of basic parameters of the visual optical system in Embodiment 2. Here, the units of a radius of curvature and a thickness/distance are millimeters (mm).

TABLE 3

| | | | | | | conic |
|---|---|---|---|---|---|---|
| surface | surface | radius of | thick- | refractive | abbe | coef- |
| number | type | curvature | ness | index | number | ficient |
| near- | spherical | infinite | 12.0000 | | | |
| eye | | | | | | |
| side | | | | | | |
| S1′ | aspheric | 62.1320 | 2.4847 | 1.54 | 55.92 | 0.0000 |
| S2′ | spherical | infinite | 0.1000 | 1.50 | 56.00 | |
| RP | spherical | infinite | 0.1000 | 1.50 | 56.00 | |
| QWP | spherical | infinite | 0.3184 | | | |
| S3′ | aspheric | 486.3949 | 0.6000 | 1.62 | 23.52 | 0.0000 |
| S4′ | aspheric | 48.0118 | 0.2260 | | | 0.0000 |
| S5′ | aspheric | 44.7715 | 9.3206 | 1.54 | 55.92 | 0.0000 |
| S6′ | aspheric | −60.5294 | 0.0000 | | | 0.0000 |
| | | | Tz/Ty | | | |
| STO | spherical | infinite | 0.0561 | | | |
| S1 | aspheric | −0.5382 | 0.3000 | 1.54 | 49.64 | 0.0000 |
| S2 | aspheric | −59.3317 | 0.0300 | | | 0.0000 |
| S3 | aspheric | 0.3930 | 0.3000 | 1.54 | 56.14 | 0.0000 |
| S4 | aspheric | 0.9957 | 0.0750 | | | 0.0000 |
| S5 | aspheric | −1.0098 | 0.5072 | 1.54 | 56.14 | 0.0000 |
| S6 | aspheric | −0.5381 | 0.0300 | | | −1.0000 |
| S7 | aspheric | 0.9938 | 0.4686 | 1.65 | 19.24 | 0.0000 |
| S8 | aspheric | 2.0973 | 0.0300 | | | 0.0000 |
| S9 | spherical | infinite | 0.2100 | 1.52 | 64.20 | |
| S10 | spherical | infinite | 0.4444 | | | |
| S11 | spherical | infinite | 0.0000 | | | |
| display | | | | | | |
| side | | | | | | |

In this Embodiment, the first side surface S1′ of the first lens element L1, the first side surface S3′ and the second side surface S4′ of the second lens element L2, the first side surface S5′ and the second side surface S6′ of the third lens element L3, the first surface S1 and the second surface S2 of the first lens E1, the first surface S3 and the second surface S4 of the second lens E2, the first surface S5 and the second surface S6 of the third lens E3, and the first surface S7 and the second surface S8 of the fourth lens E4 are all aspheric surfaces, and the surface type x of each aspheric lens may be defined using, but not limited to, the aspheric formula (1) in Embodiment 1.

Table 4 shows the high-order coefficients A₄, A₆, A₈, A₁₀, A₁₂, A₁₄ and A₁₆ applicable to the aspheric surfaces in Embodiment 2.

TABLE 4

| surface | coefficient | | | | | | |
|---|---|---|---|---|---|---|---|
| number | A4 | A6 | A8 | A10 | A12 | A14 | A16 |
| S1′ | −6.1153E−01 | −3.3166E−01 | 8.0580E−03 | −1.1441E−02 | −2.5244E−03 | 8.2930E−03 | 1.6853E−03 |
| S3′ | −6.0641E−01 | 2.6268E−01 | −7.4653E−02 | 8.7985E−02 | −2.9213E−02 | 1.9815E−03 | −7.5513E−04 |
| S4′ | −1.0827E+00 | −2.2629E−01 | −5.0583E−02 | 5.2634E−02 | −2.9721E−02 | 1.0318E−02 | 5.9363E−04 |
| S5′ | −1.6093E+00 | −1.2201E−01 | 1.8394E−02 | −3.2984E−02 | 1.2357E−02 | −1.0253E−02 | 1.6463E−03 |
| S6′ | 4.2211E−03 | −1.3171E−02 | −1.4171E−03 | 0.0000E+00 | 0.0000E+00 | 0.0000E+00 | 0.0000E+00 |
| S1 | −4.9820E−04 | −8.5735E−03 | −2.0187E−04 | 7.8926E−04 | −1.2418E−04 | −2.2426E−04 | −1.0187E−05 |
| S2 | −7.3658E−02 | 1.4461E−02 | −3.2792E−03 | 9.4565E−04 | −4.1960E−04 | −1.0050E−05 | −1.1930E−04 |
| S3 | −1.7375E−01 | 7.2456E−03 | −5.5176E−03 | 6.5799E−04 | −3.9686E−04 | 1.6944E−04 | −4.1445E−05 |
| S4 | −8.9329E−02 | −6.4437E−03 | 6.5873E−05 | −2.6281E−04 | −1.3780E−05 | 1.5518E−05 | −5.6596E−06 |
| S5 | 9.7945E−02 | −1.4810E−02 | 4.3659E−03 | −8.7729E−04 | 1.4100E−04 | 3.3040E−05 | 1.5118E−05 |
| S6 | −9.2934E−03 | 1.7298E−02 | 5.5158E−03 | −1.7493E−03 | 4.0194E−04 | −3.3446E−04 | 8.4028E−05 |
| S7 | −2.7015E−01 | 1.7947E−02 | 8.2099E−03 | −1.6157E−03 | 9.4741E−04 | −1.2046E−03 | 3.1861E−04 |
| S8 | −3.5002E−01 | 2.3383E−02 | 5.8652E−03 | −6.5533E−04 | 2.3091E−03 | −4.4268E−04 | 4.9400E−04 |

FIG. 8 illustrates a diffraction MTF curve graph of the visual optical system according to Embodiment 2 at different fields-of-view. Here, the horizontal axis, Spatial Frequency, represents the spatial frequency in line pairs per millimeter (lp/mm), and the vertical axis, Modulation, represents the Modulation Transfer Function. As can be seen from FIG. 8, the visual optical system of this embodiment exhibits good contrast within a spatial frequency of 30 lp/mm, demonstrating a high overall resolution level.

### Embodiment 3

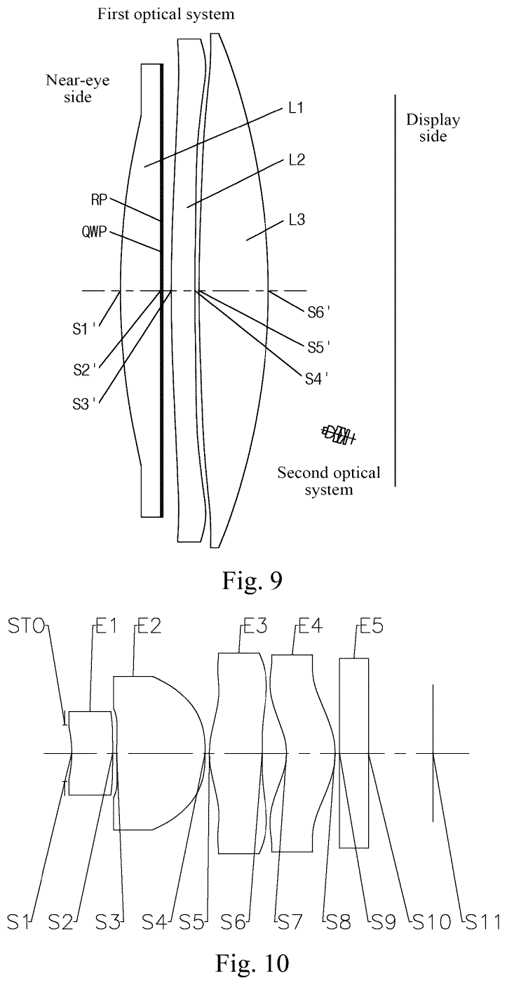

A visual optical system according to Embodiment 3 of the present disclosure is described below with reference to FIGS. 9-11. FIG. 9 is a schematic structural diagram of the visual optical system according to Embodiment 3 of the present disclosure.

As shown in FIG. 9, the visual optical system in this embodiment may include a first optical system and a second optical system. The first optical system includes: a first element group, a second element group, and a third element group sequentially arranged along a first optical axis from a near-eye side to a display side, where the first element group includes a first lens element L1, a reflective polarizing element RP, and a quarter wave plate QWP; the second element group includes a second lens element L2; and the third element group includes a third lens element L3. A display may be arranged on a second side of the first optical system.

In this embodiment, the first lens element L1 has a positive refractive power, a first side surface S1′ of the first lens element L1 is a convex surface, and a second side surface S2′ of the first lens element L1 is a planar surface. The reflective polarizing element RP is at least partially attached to the second side surface S2′ of the first lens element L1, and the quarter wave plate QWP is at least partially attached to a second side surface of the reflective polarizing element RP.

The second lens element L2 has a positive refractive power, a first side surface S3′ of the second lens element L2 is a convex surface, and a second side surface S4′ of the second lens element L2 is a concave surface.

The third lens element L3 has a positive refractive power, a first side surface S5′ of the third lens element L3 is a convex surface, and a second side surface S6′ of the third lens element L3 is a convex surface.

As shown in FIG. 10, the second optical system includes: a first lens E1, a second lens E2, a third lens E3, and a fourth lens E4 sequentially arranged along a second optical axis from an object side to an image side. The second optical system may further include a diaphragm STO disposed on a side closer to a first surface of the first lens E1, and a protective glass or an optical filter E5 for protecting a photosensitive element disposed on an image plane S11.

In this embodiment, the first lens E1 may have a negative refractive power, the first surface S1 of the first lens E1 is a concave surface, and a second surface S2 of the first lens E1 is a convex surface. The second lens E2 may have a positive refractive power, a first surface S3 of the second lens E2 is a convex surface, and a second surface S4 of the second lens E2 is a convex surface. The third lens E3 may have a positive refractive power, a first surface S5 of the third lens E3 is a convex surface, and a second surface S6 of the third lens E3 is a convex surface. The fourth lens E4 may have a positive refractive power, a first surface S7 of the fourth lens E4 is a concave surface, and a second surface S8 of the fourth lens E4 is a convex surface.

Table 5 shows a table of basic parameters of the visual optical system in Embodiment 3. Here, the units of a radius of curvature and a thickness/distance are millimeters (mm).

TABLE 5

| | | | | | | conic |
|---|---|---|---|---|---|---|
| surface | surface | radius of | thick- | refractive | abbe | coef- |
| number | type | curvature | ness | index | number | ficient |
| near- | spherical | infinite | 12.0000 | | | |
| eye | | | | | | |
| side | | | | | | |
| S1′ | aspheric | 66.6014 | 3.6893 | 1.54 | 55.92 | 0.0000 |
| S2′ | spherical | infinite | 0.1000 | 1.50 | 56.00 | |
| RP | spherical | infinite | 0.1000 | 1.50 | 56.00 | |
| QWP | spherical | infinite | 0.5000 | | | |
| S3′ | aspheric | 165.3041 | 2.0421 | 1.54 | 55.92 | 0.0000 |
| S4′ | aspheric | 181.2680 | 0.2421 | | | 0.0000 |
| S5′ | aspheric | 140.1847 | 6.8952 | 1.54 | 55.92 | 0.0000 |
| S6′ | aspheric | −61.4727 | 0.0000 | | | 0.0000 |
| | | | Tz/Ty | | | |
| STO | spherical | infinite | 0.0503 | | | |
| S1 | aspheric | −0.8208 | 0.3000 | 1.65 | 19.24 | 0.0000 |
| S2 | aspheric | −12.7945 | 0.0300 | | | 0.0000 |
| S3 | aspheric | 2.5746 | 0.6474 | 1.54 | 56.14 | 0.0000 |
| S4 | aspheric | −1.5709 | 0.0300 | | | 0.0000 |
| S5 | aspheric | 0.5649 | 0.3845 | 1.65 | 19.24 | 1.0000 |
| S6 | aspheric | −110.1102 | 0.1812 | | | 0.0000 |
| S7 | aspheric | −0.3562 | 0.3573 | 1.65 | 19.24 | 1.0000 |
| S8 | aspheric | −0.4837 | 0.0300 | | | 1.0000 |
| S9 | spherical | infinite | 0.2100 | 1.52 | 64.20 | |
| S10 | spherical | infinite | 0.4700 | | | |
| S11 | spherical | infinite | 0.0000 | | | |
| display | | | | | | |
| side | | | | | | |

In this Embodiment, the first side surface S1′ of the first lens element L1, the first side surface S3′ and the second side surface S4′ of the second lens element L2, the first side surface S5′ and the second side surface S6′ of the third lens element L3, the first surface S1 and the second surface S2 of the first lens E1, the first surface S3 and the second surface S4 of the second lens E2, the first surface S5 and the second surface S6 of the third lens E3, and the first surface S7 and the second surface S8 of the fourth lens E4 are all aspheric surfaces, and the surface type x of each aspheric lens may be defined using, but not limited to, the aspheric formula (1) in Embodiment 1.

Table 6 shows the high-order coefficients A₄, A₆, A₈, A₁₀, A₁₂, A₁₄ and A₁₆ applicable to the aspheric surfaces in Embodiment 3.

TABLE 6

| surface | coefficient | | | | | | |
|---|---|---|---|---|---|---|---|
| number | A4 | A6 | A8 | A10 | A12 | A14 | A16 |
| S1′ | −7.7832E−02 | −8.0278E−02 | −4.4280E−02 | 1.4286E−02 | −4.7680E−03 | −5.9445E−04 | −3.2749E−04 |
| S3′ | −5.2647E−01 | 1.7378E−02 | 1.4687E−03 | −5.6363E−04 | −5.7278E−03 | −2.4342E−03 | 4.0963E−04 |
| S4′ | −2.6318E−01 | 1.4742E−01 | −2.4382E−01 | 4.3098E−02 | −4.1613E−03 | −1.4102E−02 | 3.0397E−03 |
| S5′ | −6.2284E−01 | 1.6363E−01 | −1.1425E−01 | 1.3515E−02 | 6.2756E−03 | −5.2626E−03 | 1.3959E−03 |
| S6′ | 6.3214E−03 | −1.1485E−02 | −1.2245E−03 | 0.0000E+00 | 0.0000E+00 | 0.0000E+00 | 0.0000E+00 |
| S1 | 6.8284E−03 | 1.2037E−03 | −2.5648E−04 | −4.7790E−04 | −7.8780E−05 | 1.0009E−04 | 5.9897E−05 |
| S2 | −1.7784E−02 | 8.1732E−04 | 6.7395E−04 | −4.7719E−04 | −6.4161E−05 | −5.4723E−06 | 4.5873E−05 |
| S3 | −2.6452E−02 | −2.2731E−03 | 2.2717E−04 | −2.4817E−05 | 4.3056E−05 | −4.4646E−06 | −1.7366E−06 |
| S4 | −1.6176E−01 | 1.6784E−02 | −4.2081E−03 | 7.5609E−04 | −1.6367E−04 | 2.5706E−05 | −2.0275E−06 |
| S5 | −2.6831E−01 | 3.0533E−02 | −1.1849E−03 | 1.3026E−03 | −9.8386E−04 | 2.5726E−04 | −2.3243E−05 |
| S6 | 3.3216E−02 | −4.1884E−02 | 1.5195E−02 | −5.3015E−03 | 1.7863E−03 | −4.6230E−04 | 7.3275E−05 |
| S7 | 6.3444E−01 | −9.6065E−02 | 1.1493E−02 | −3.8338E−03 | 1.3512E−03 | −4.7694E−04 | 2.2642E−04 |
| S8 | 3.9081E−01 | −2.6407E−02 | −5.3217E−03 | −1.2048E−03 | 1.0537E−03 | 3.2836E−04 | −5.6476E−05 |

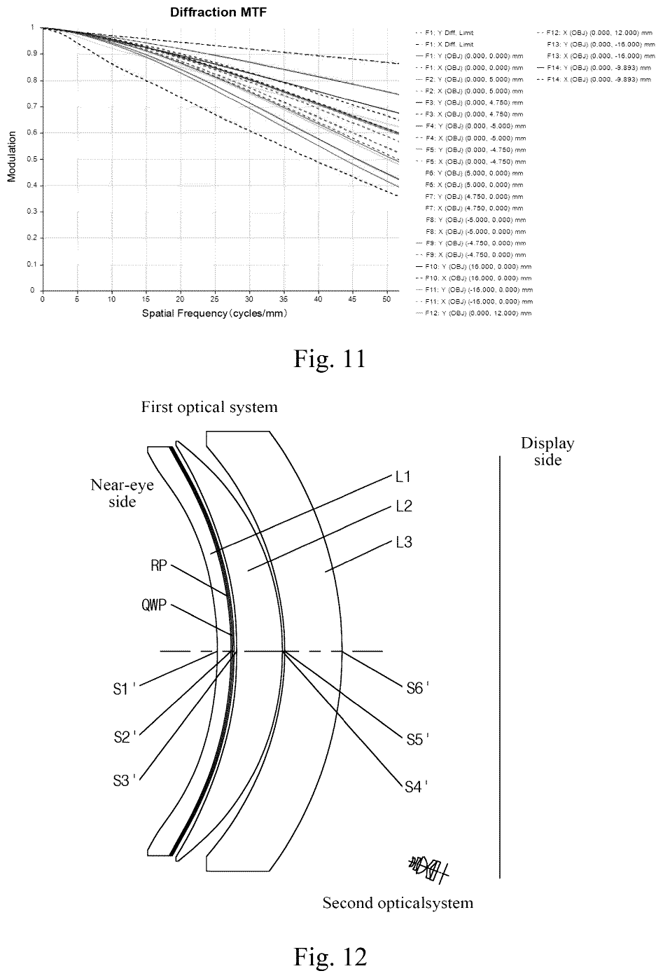

FIG. 11 illustrates a diffraction MTF curve graph of the visual optical system according to Embodiment 3 at different fields-of-view. Here, the horizontal axis, Spatial Frequency, represents the spatial frequency in line pairs per millimeter (lp/mm), and the vertical axis, Modulation, represents the Modulation Transfer Function. As can be seen from FIG. 11, the visual optical system of this embodiment exhibits good contrast within a spatial frequency of 30 lp/mm, demonstrating a high overall resolution level.

### Embodiment 4

A visual optical system according to Embodiment 4 of the present disclosure is described below with reference to FIGS. 12-14. FIG. 12 is a schematic structural diagram of the visual optical system according to Embodiment 4 of the present disclosure.

As shown in FIG. 12, the visual optical system in this embodiment may include a first optical system and a second optical system. The first optical system includes: a first element group, a second element group, and a third element group sequentially arranged along a first optical axis from a near-eye side to a display side, where the first element group includes a first lens element L1, a reflective polarizing element RP, and a quarter wave plate QWP; the second element group includes a second lens element L2; and the third element group includes a third lens element L3. A display may be arranged on a second side of the first optical system.

In this embodiment, the first lens element L1 has a negative refractive power, a first side surface S1′ of the first lens element L1 is a concave surface, and a second side surface S2′ of the first lens element L1 is a convex surface. The reflective polarizing element RP is at least partially attached to the second side surface S2′ of the first lens element L1, and the quarter wave plate QWP is at least partially attached to a second side surface of the reflective polarizing element RP.

The second lens element L2 has a positive refractive power, a first side surface S3′ of the second lens element L2 is a concave surface, and a second side surface S4′ of the second lens element L2 is a convex surface.

The third lens element L3 has a negative refractive power, a first side surface S5′ of the third lens element L3 is a concave surface, and a second side surface S6′ of the third lens element L3 is a convex surface.

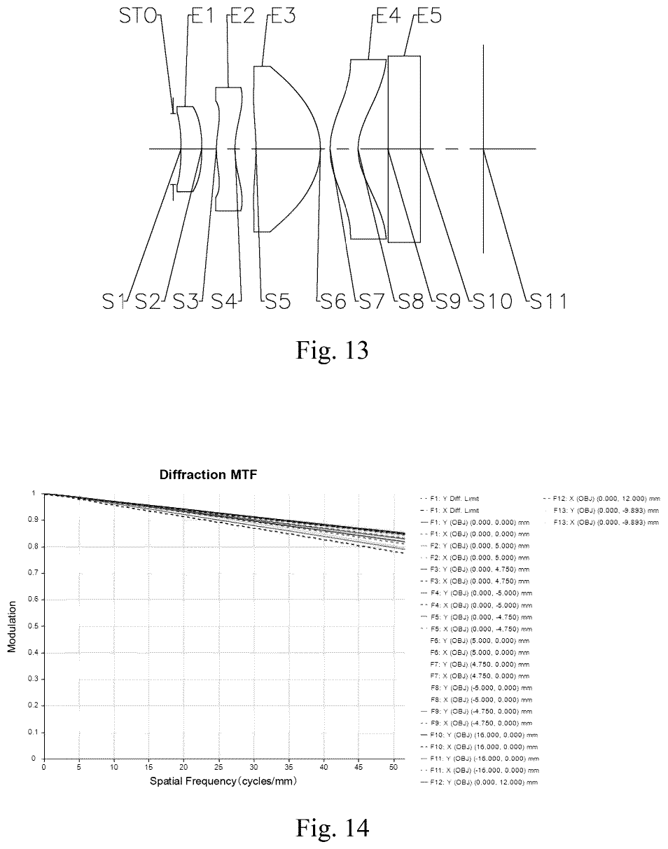

As shown in FIG. 13, the second optical system includes: a first lens E1, a second lens E2, a third lens E3, and a fourth lens E4 sequentially arranged along a second optical axis from an object side to an image side. In this embodiment, the second optical system may further include a diaphragm STO disposed on a side closer to a first surface of the first lens E1, and a protective glass or an optical filter E5 for protecting a photosensitive element disposed on an image plane S11.

In this embodiment, the first lens E1 may have a positive refractive power, the first surface S1 of the first lens E1 is a concave surface, and a second surface S2 of the first lens E1 is a convex surface. The second lens E2 may have a positive refractive power, a first surface S3 of the second lens E2 is a concave surface, and a second surface S4 of the second lens E2 is a concave surface. The third lens E3 may have a positive refractive power, a first surface S5 of the third lens E3 is a concave surface, and a second surface S6 of the third lens E3 is a convex surface. The fourth lens E4 may have a negative refractive power, a first surface S7 of the fourth lens E4 is a convex surface, and a second surface S8 of the fourth lens E4 is a concave surface.

Table 7 shows a table of basic parameters of the visual optical system in Embodiment 4. Here, the units of a radius of curvature and a thickness/distance are millimeters (mm).

TABLE 7

| | | | | | | conic |
|---|---|---|---|---|---|---|
| surface | surface | radius of | thick- | refractive | abbe | coef- |
| number | type | curvature | ness | index | number | ficient |
| near- | spherical | infinite | 12.0000 | | | |
| eye | | | | | | |
| side | | | | | | |
| S1′ | aspheric | −18.5496 | 0.7897 | 1.62 | 23.52 | 0.0000 |
| S2′ | aspheric | −21.6377 | 0.1000 | 1.50 | 56.00 | |
| RP | aspheric | −21.6377 | 0.1000 | 1.50 | 56.00 | |
| QWP | aspheric | −21.6377 | 0.2500 | | | |
| S3′ | aspheric | −30.7029 | 3.2751 | 1.54 | 55.92 | 0.0000 |
| S4′ | aspheric | −15.9703 | 0.2500 | | | 0.0000 |
| S5′ | aspheric | −16.2887 | 3.5000 | 1.62 | 23.52 | 0.0000 |
| S6′ | aspheric | −21.5780 | 0.0000 | | | 0.0000 |
| | | | Tz/Ty | | | |
| STO | spherical | infinite | 0.0534 | | | |
| S1 | aspheric | −1.3967 | 0.1373 | 1.57 | 29.91 | 0.0000 |
| S2 | aspheric | −1.1220 | 0.0962 | | | 0.0000 |
| S3 | aspheric | −4.1421 | 0.1201 | 1.65 | 19.24 | 0.0000 |
| S4 | aspheric | 2.2855 | 0.1458 | | | 0.0000 |
| S5 | aspheric | −8.5185 | 0.4485 | 1.54 | 56.14 | 0.0000 |
| S6 | aspheric | −0.5777 | 0.0174 | | | −1.0000 |
| S7 | aspheric | 2.0319 | 0.1752 | 1.65 | 19.24 | −1.0000 |
| S8 | aspheric | 1.6539 | 0.1861 | | | −1.0000 |
| S9 | spherical | infinite | 0.2100 | 1.52 | 64.20 | |
| S10 | spherical | infinite | 0.4443 | | | |
| S11 | spherical | infinite | 0.0000 | | | |
| display | | | | | | |
| side | | | | | | |

In this Embodiment, the first side surface S1′ and the second side surface S2′ of the first lens element L1, the first side surface S3′ and the second side surface S4′ of the second lens element L2, the first side surface S5′ and the second side surface S6′ of the third lens element L3, the first surface S1 and the second surface S2 of the first lens E1, the first surface S3 and the second surface S4 of the second lens E2, the first surface S5 and the second surface S6 of the third lens E3, and the first surface S7 and the second surface S8 of the fourth lens E4 are all aspheric surfaces, and the surface type x of each aspheric lens may be defined using, but not limited to, the aspheric formula (1) in Embodiment 1.

Table 8 shows the high-order coefficients A₄, A₆, A₈, A₁₀, A₁₂, A₁₄ and A₁₆ applicable to the aspheric surfaces in Embodiment 4.

TABLE 8

| surface | coefficient | | | | | | |
|---|---|---|---|---|---|---|---|
| number | A4 | A6 | A8 | A10 | A12 | A14 | A16 |
| S1′ | −1.1242E−01 | 2.1702E−02 | 1.8514E−01 | −2.8267E−03 | 1.3801E−02 | −1.4578E−02 | 3.2945E−03 |
| S2′ | −5.2829E−02 | 1.0902E−01 | 3.1306E−02 | 6.8431E−03 | 1.6485E−03 | 6.1464E−04 | −9.2957E−04 |
| S3′ | −1.5098E+00 | 3.4975E−01 | −2.2104E−01 | 4.1582E−02 | −5.3277E−02 | 1.1293E−02 | −9.2157E−03 |
| S4′ | −3.9932E−01 | −3.5499E−02 | 7.9833E−02 | 1.7820E−02 | 3.6225E−02 | −4.3785E−03 | 1.6630E−03 |
| S5′ | 1.1224E+00 | −1.0458E−01 | 6.5785E−02 | −1.9573E−02 | 2.5698E−02 | −3.9078E−03 | 3.1698E−03 |
| S6′ | 9.3449E−03 | −1.3907E−03 | −1.2398E−04 | 0.0000E+00 | 0.0000E+00 | 0.0000E+00 | 0.0000E+00 |
| S1 | −2.3683E−02 | −2.5877E−03 | −4.9194E−04 | −6.6926E−05 | −5.4380E−05 | −3.4536E−05 | −1.4807E−05 |
| S2 | −3.0421E−02 | 7.2981E−04 | −3.4213E−04 | 9.3350E−06 | −6.6429E−06 | 1.9763E−06 | 1.8429E−06 |
| S3 | −8.9467E−02 | −2.0244E−03 | −4.1298E−04 | −1.8461E−04 | −2.8392E−05 | −6.7493E−06 | −1.2150E−06 |
| S4 | −1.1830E−01 | −1.4939E−03 | 3.6218E−04 | −6.3973E−04 | 1.5840E−04 | −4.1661E−05 | 8.1538E−06 |
| S5 | 8.8540E−02 | −1.3076E−02 | 1.7821E−03 | −4.2198E−04 | 1.2878E−04 | −4.5006E−05 | 1.3715E−05 |
| S6 | −9.4144E−03 | 1.4248E−03 | 2.8232E−03 | 4.5450E−04 | 2.1786E−05 | −2.6140E−05 | −6.2361E−06 |
| S7 | −4.5485E−01 | 4.5717E−02 | −5.2047E−04 | 9.4696E−04 | 7.1605E−05 | −3.8705E−04 | 5.9336E−05 |
| S8 | −7.9021E−01 | 1.1645E−01 | −1.8970E−02 | 6.9221E−03 | −1.5486E−03 | 3.1619E−04 | −6.0664E−05 |

FIG. 14 illustrates a diffraction MTF curve graph of the visual optical system according to Embodiment 4 at different fields-of-view. Here, the horizontal axis, Spatial Frequency, represents the spatial frequency in line pairs per millimeter (lp/mm), and the vertical axis, Modulation, represents the Modulation Transfer Function. As can be seen from FIG. 14, the visual optical system of this embodiment exhibits good contrast within a spatial frequency of 30 lp/mm, demonstrating a high overall resolution level.

Table 9 shows optical parameters of the visual optical systems in Embodiments 1-4, including a focal length f of the visual optical system, a focal length of each lens, relevant parameters such as a spacing distance Tz along the first optical axis from an intersection point of the second side surface of the element group closest to the display side in the first optical system and the first optical axis, to an intersection point of a center of the diaphragm in the second optical system and the second optical axis, and a spacing distance Ty along a direction perpendicular to the first optical axis from the intersection point of the second side surface of the element group closest to the display side in the first optical system and the first optical axis, to the intersection point of the center of the diaphragm in the second optical system and the second optical axis. Here, the units of a distance and a focal length value are millimeters (mm).

TABLE 9

embodiment

| parameter | 1 | 2 | 3 | 4 |
|---|---|---|---|---|
| f(mm) | 1.00 | 0.99 | 1.06 | 0.91 |
| f1m(mm) | 175.66 | 115.83 | 124.16 | −237.08 |
| f2m(mm) | 173.53 | −86.00 | 3349.61 | 57.58 |
| f3m(mm) | 297.47 | 49.51 | 80.63 | −143.57 |
| fle(mm) | −1.71 | −1.00 | −1.37 | 8.45 |
| f2e(mm) | 1.50 | 1.03 | 1.92 | 625.71 |
| f3e(mm) | 1.62 | 1.56 | 0.87 | 0.99 |
| f4e(mm) | 1.61 | 2.50 | 20.75 | −4.01 |
| Tz(mm) | 0.00 | 9.03 | 3.66 | 1.29 |
| Ty(mm) | 11.41 | 18.39 | 12.00 | 12.00 |

In summary, the visual optical systems in Embodiments 1˜4 satisfy the conditions shown in Table 10 below.

TABLE 10

| | embodiment | | | |
|---|---|---|---|---|
| parameter | 1 | 2 | 3 | 4 |
| TDm/TDe | 13.15 | 7.69 | 7.03 | 7.25 |
| f1m/f3m | 0.59 | 2.34 | 1.54 | 1.65 |
| TDm/f3m | 0.07 | 0.27 | 0.17 | −0.06 |
| CT3m/TDm | 0.17 | 0.71 | 0.51 | 0.42 |
| (N1m + N2m)*T12m/(f2m/f1m) | 1.56 | −1.35 | 0.06 | −3.25 |
| N3m/N1e | 0.98 | 1.00 | 0.93 | 1.03 |
| V3m − V1e | 26.01 | 6.29 | 36.69 | 6.39 |
| TTLe/TDe | 1.45 | 1.40 | 1.37 | 1.74 |
| (N2e*CT2e)/(N3e*CT3e) | 0.69 | 0.59 | 1.57 | 0.29 |
| f1e/f2e | −1.14 | −0.97 | −0.71 | 0.01 |
| f3e/f4e | 1.00 | 0.62 | 0.04 | 0.25 |
| R1m/R3m | 0.54 | 0.13 | 0.40 | 0.60 |
| R6m/R5m | 0.29 | −1.35 | −0.44 | 1.32 |
| \|R8e\|/Rle | −0.08 | −3.90 | −0.59 | −1.18 |
| f3e/(R5e + R6e) | −0.51 | −1.01 | −0.01 | −0.11 |

The foregoing is only a description for the preferred embodiments of the present disclosure and the applied technical principles. It should be appreciated by those skilled in the art that the scope of protection of the present disclosure is not limited to the technical solution formed by the particular combinations of the above technical features. The scope of protection should also cover other technical solutions formed by any combination of the above technical features or equivalent features thereof without departing from the concept of the present disclosure, such as, technical solutions formed by replacing the features as disclosed in the present disclosure with (but not limited to) technical features with similar functions.

What is claimed is:

1. A visual optical system, comprising a first optical system and a second optical system, wherein,
the first optical system sequentially comprises: a first element group, a second element group and a third element group along a first optical axis from a near-eye side to a display side, the first element group comprising a first lens element, a reflective polarizing element and a quarter wave plate; the second element group comprising a second lens element; and the third element group comprising a third lens element;
the second optical system sequentially comprises: a first lens having a refractive power, a second lens having a positive refractive power, a third lens having a positive refractive power and a fourth lens having a refractive power along a second optical axis from a first side to a second side;
wherein, a distance TDm from a first side surface of the first element group to a second side surface of the third element group on the first optical axis and a distance TDe from a first surface of the first lens to a second surface of the fourth lens on the second optical axis satisfy: 5.0<TDm/TDe<15.0.

2. The visual optical system according to claim 1, wherein a focal length f1m of the first element group and a focal length f3m of the third element group satisfy: 0.3<f1m/f3m<2.5.

3. The visual optical system according to claim 1, wherein the distance TDm from the first side surface of the first element group to the second side surface of the third element group on the first optical axis and a focal length f3m of the third element group satisfy: −0.01<TDm/f3m<0.50.

4. The visual optical system according to claim 1, wherein the distance TDm from the first side surface of the first element group to the second side surface of the third element group on the first optical axis and a center thickness CT3m of the third lens element on the first optical axis satisfy: 0.1<CT3m/TDm<0.9.

5. The visual optical system according to claim 1, wherein a refractive index N1m of the first lens element, a refractive index N2m of the second lens element, an air spacing T12m between the first element group and the second element group on the first optical axis, a focal length f1m of the first element group, and a focal length f2m of the second element group satisfy: −3.5<(N1m+N2m)*T12m/(f2m/f1m)<2.0.

6. The visual optical system according to claim 1, wherein a refractive index N3m of the third lens element and a refractive index N1e of the first lens satisfy: 0.8<N3m/N1e<1.20; and an abbe number V3m of the third lens element and an abbe number V1e of the first lens satisfy: 0</V3m−V1e|<40.0.

7. The visual optical system according to claim 1, wherein a distance TTLe from the first surface of the first lens to an image plane on the second optical axis and the distance TDe from the first surface of the first lens to the second surface of the fourth lens on the second optical axis satisfy: 1.30<TTLe/TDe<1.80.

8. The visual optical system according to claim 1, wherein a refractive index N2e of the second lens, a refractive index N3e of the third lens, a center thickness CT2e of the second lens on the second optical axis and a center thickness CT3e of the third lens on the second optical axis satisfy: 0.2<(N2e*CT2e)/(N3e*CT3e)<1.8.

9. The visual optical system according to claim 1, wherein a focal length f1e of the first lens and a focal length f2e of the second lens satisfy: −1.50<f1e/f2e<0.09.

10. The visual optical system according to claim 1, wherein a focal length f3e of the third lens and a focal length f4e of the fourth lens satisfy: 0.01<|f3e/f4e|<1.20.

11. The visual optical system according to claim 1, wherein a radius of curvature R1m of a first side surface of the first lens element and a radius of curvature R3m of a first side surface of the second lens element satisfy: 0<R1m/R3m<1.0.

12. The visual optical system according to claim 1, wherein a radius of curvature R5m of a first side surface of the third lens element and a radius of curvature Rom of a second side surface of the third lens element satisfy: −2.0<R6m/R5m<2.0.

13. The visual optical system according to claim 1, wherein a radius of curvature R1e of the first surface of the first lens and a radius of curvature R8e of the second surface of the fourth lens satisfy: −5.0<|R8e|/R1e<0.

14. The visual optical system according to claim 1, wherein a focal length f3e of the third lens, a radius of curvature R5e of a first surface of the third lens, and a radius of curvature R6e of a second surface of the third lens satisfy: −2.0<f3e/(R5e+R6e)<0.

15. The visual optical system according to claim 1, wherein a total focal length f of the visual optical system satisfies: 0.8<f<1.5.

16. The visual optical system according to claim 1, wherein the second optical system is disposed between the first optical system and the display side, the first side of the second optical system is relatively closer to the near-eye side, and the second side of the second optical system is relatively closer to the display side.

17. The visual optical system according to claim 1, wherein an included angle θ between the second optical axis and the first optical axis satisfies: 0°<θ<90°.

18. The visual optical system according to claim 1, wherein the second optical system further includes a diaphragm, and the diaphragm is disposed on a side closer to the first surface of the first lens; and a spacing distance Tz along the first optical axis from an intersection point of the second side surface of the element group closest to the display side in the first optical system and the first optical axis, to an intersection point of a center of the diaphragm in the second optical system and the second optical axis satisfy: 0 mm<Tz<15.0 mm.

19. The visual optical system according to claim 1, wherein the second optical system further includes a diaphragm, and the diaphragm is disposed on a side closer to the first surface of the first lens; and a spacing distance Ty along a direction perpendicular to the first optical axis from an intersection point of the second side surface of the element group closest to the display side in the first optical system and the first optical axis, to an intersection point of a center of the diaphragm in the second optical system and the second optical axis satisfy: 5 mm<Ty<25.0 mm.

20. The visual optical system according to claim 1, wherein a second side surface of the first lens element is at least partially attached to the reflective polarizing element, and a second side surface of the reflective polarizing element is at least partially attached to the quarter wave plate; and the second side surface of the first lens element is a planar surface.
